(19) United States
(12) Patent Application Publication
(10) Pub. No.: US 2010/0036733 A1
(43) Pub. Date: Feb. 11, 2010

(54) METHOD AND SYSTEM FOR DYNAMICALLY UPDATING ONLINE ADVERTISEMENTS

(75) Inventors: Shan-Bin Chris Chan, Yuan Lin Town (TW); Po-Tsung Hill Liu, Lujhou City (TW)

Correspondence Address: Yahoo! Inc., c/o Kenyon & Kenyon LLP, 333 W. San Carlos Street, Suite 600, San Jose, CA, 95110, US

(73) Assignee: YAHOO! INC., Sunnyvale, CA (US)

(21) Appl. No.: 12/187,324

(22) Filed: Aug. 6, 2008

(51) Int. Cl. G06Q 30/00; G06F 17/30

(52) U.S. Cl. 705/14.54

(57) ABSTRACT

A system and method for improving precision of online advertisement targeting. Upon receiving a search request including one or more search terms, a search engine may identify a list of search results and display the search results in a first portion of a result page. The search engine may also obtain a list of advertisements and display the list of advertisements in a second portion of the result page. If a user is interested in a part of the result page, which may be a search result or an advertisement, he may mouse over it or click on the link to open the web page and get more information. A user activity analyzing module may collect information about the user's browsing activities on the result page, analyze the user's interest, and send one or more supplemental search terms to the search engine, so that the search engine may dynamically update the advertisement list with the supplemental search terms.

### CROSS REFERENCE TO RELATED APPLICATION

The present application is related to the following U.S. patent application, which is assigned to the assignee hereof and incorporated herein by reference in its entirety: U.S. patent application Ser. No. 11/______ (Attorney Docket No. 14093/4456), entitled Method and System for Displaying Online Advertisements, and filed concurrently herewith.

### BACKGROUND

1. Field of the Invention

The present invention relates generally to online advertising, and more particularly to display of online advertisements.

2. Description of Related Art

A search engine may allow users to search for web pages or other materials accessible over the Internet with one or more search terms. After receiving from a user a search request including one or more search terms, a search engine may parse the search term(s) from the search request, identify web pages that may be related to the search term(s), and display on a result page information about the web pages as a list of search results, e.g., a link to a web page containing the search term(s). The search results may be ranked according to their relevance to the search terms, with the most relevant search result being positioned at the top of the list. The relevance may be determined according to search engine algorithms of a search engine service provider.

The search engine service provider may also display advertisements as a separate list on a result page displaying the search results. The search engine service provider may sign contracts with a number of advertisers (e.g., Macy's™, and GM™), and display a link to an advertiser's website when a search term in a search request is related to the advertiser's products or services. For example, when the search terms include “camera,” a list of relevant search results may be displayed at one portion of a result page, and a list of advertisements may be displayed at another portion of the result page. An advertisement may include some brief information about a camera manufacturer or a camera store, and a link to its website. An advertiser may be charged according to the number of clicks on its link (Pay Per Click) or the number of times its advertisement is displayed (Pay Per Impression). Since the advertisements are related to the search term(s) of a search request, it is more likely that the user will be interested in the advertisements, and in this way advertising may be better targeted at users.

The list of relevant search results may go on for a number of result pages, and each result page may expand over several screens. The list of advertisements may be shorter than a screen. Some currently available solutions determine the list of advertisements during the search and then keep the list unchanged when the user browses through the result pages. However, the user may not know or input all search terms necessary to define what he is really interested in. Since the advertisements in the list are selected solely based on the user input search terms, they may be only roughly related to the user's interest, and sometimes very off.

Therefore, it may be desirable to provide a system and method which may help to improve the precision of online advertisement targeting.

### BRIEF DESCRIPTION OF THE DRAWING FIGURES

Embodiments of the present invention are described herein with reference to the accompanying drawings, similar reference numbers being used to indicate functionally similar elements.

FIG. 1 illustrates an online advertising system in which a system of the present invention may be used.

FIG. 2A illustrates a system for dynamically updating online advertisements according to one embodiment of the present invention.

FIG. 2B illustrates a system for dynamically updating online advertisements according to one embodiment of the present invention.

FIG. 3 illustrates a flow chart of a method for dynamically updating online advertisements according to one embodiment of the present invention.

### DETAILED DESCRIPTION

The present invention provides a system and method for improving precision of online advertisement targeting. Upon receiving a search request including one or more search terms, a search engine may identify a list of search results and display the search results in one portion of a result page. The search engine may also obtain a list of advertisements and display the list of advertisements in another portion of the result page. The user may be more interested in some search results or advertisements than other search results or advertisements. If a user is interested in a part of the result page, which may be a search result or an advertisement, he may mouse over it or click on the link to open the web page and get more information. A user activity analyzing module may collect information about a user's browsing activities on the result page, analyze the user's interest, and send one or more supplemental search terms to the search engine, so that the search engine may dynamically update the advertisement list with the supplemental search terms. Since the online advertisements are fine tuned to the user's interest and thus better targeted at the user, it is more likely that the online advertisements may get the user's attention, and consequently it is more likely for the user to click on an online advertisement. As a result, the precision of the online advertisement targeting may be improved, and at the same time the search engine service provider's revenue may increase. The invention may be carried out by computer-executable instructions, such as program modules. Advantages of the present invention will become apparent from the following detailed description.

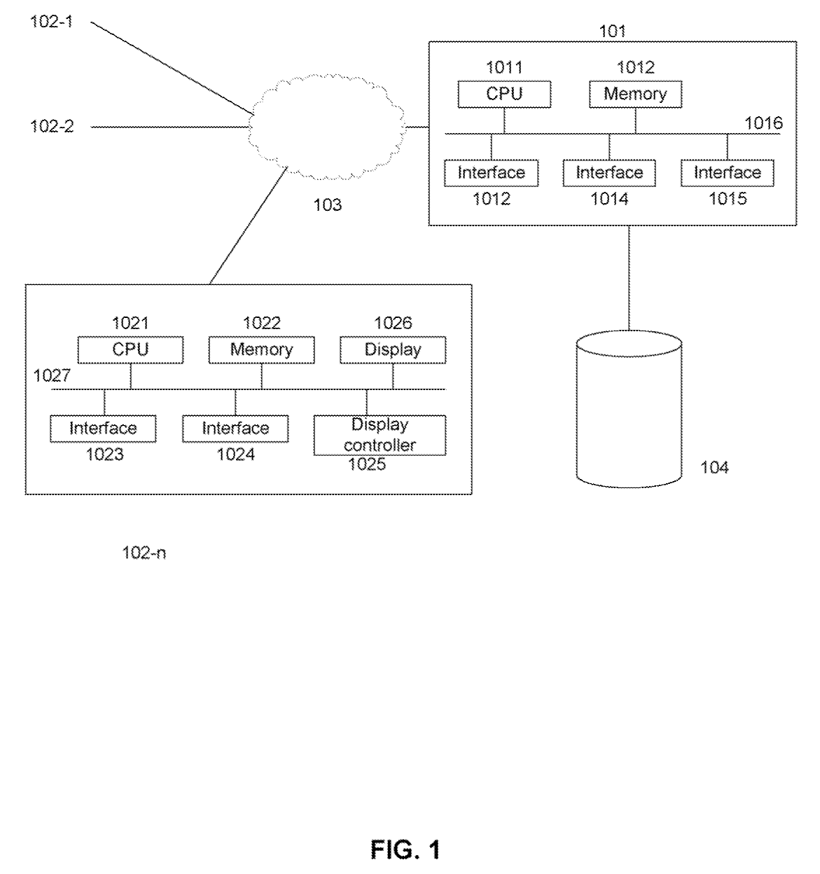

FIG. 1 illustrates an online advertising system in which a system of the present invention may be used. As shown, a number of user terminals 102-1, 102-2, . . . 102-n may communicate with a data server 101 over a computer network 103, and the data server 101 may access an advertisement database 104.

The data server 101 may be a computer system, including a central processing unit (CPU) 1011, a memory 1012, an interface 1013 to external storage devices, an interface 1014 to the Internet, a user interface 1015, etc. All of these elements may be interconnected by a system bus 1016. Alternatively, the data server 101 may include multiple computer systems each configured to accomplish certain tasks and coordinate with other computer systems to perform the method of the present invention.

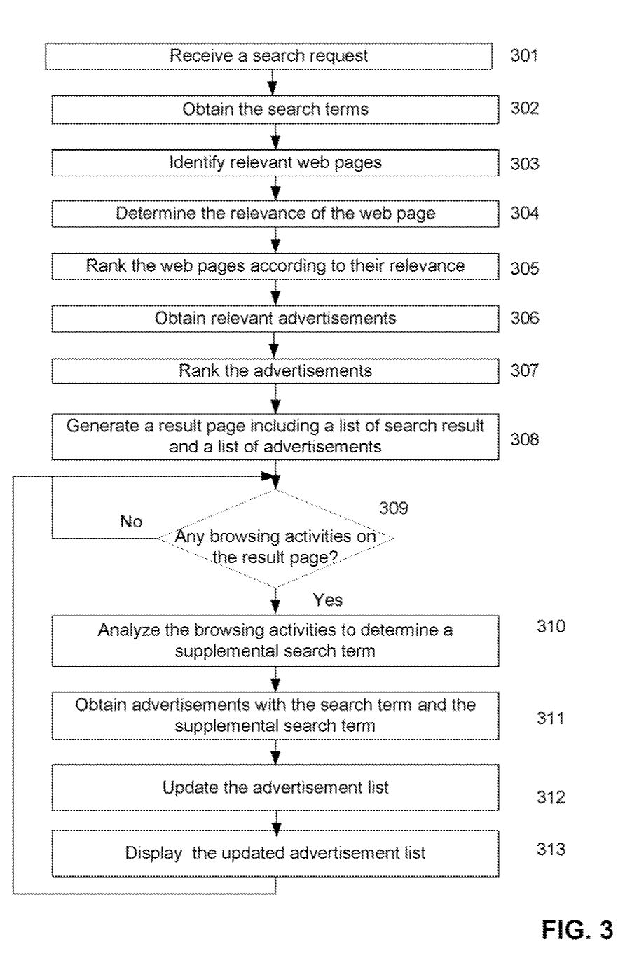

The CPU 1011 may control the data server 101 to carry out a number of processes, including but not limited to the one described below with reference to FIG. 3. The processes may be stored in the memory 1012. In one example, the CPU 1011 may receive a search request over the computer network 103, parse one or more search term(s) from the search request, identify web pages relevant to the search term(s), determine relevance of the web pages to the search terms, rank the web pages, and generate a result page with the web pages being displayed as a list of search results at one part of the result page, e.g., the left side.

The data server 101 may also access the advertisement database 104 via the interface 1013 to obtain advertisements relevant to the search term(s), rank the advertisements (e.g., according to the service fee rates) and display the advertisements as a list of advertisements on another part of the result page, e.g., the right side.

The user terminals 102-1, 102-2, . . . 102-n may be a desktop computer, a laptop computer, a personal digital assistant (PDA), a smartphone, a set top box or any electronic devices having access to the computer network 103. A user terminal may have a CPU 1021, a memory 1022, a user interface 1023, an interface 1024 to the Internet, a display controller 1025 and a display 1026, interconnected via a bus 1027. The user terminal may also have a browser application configured to receive and display web pages, which may include text, graphics, multimedia, etc. The web pages may be based on, e.g., HyperText Markup Language (HTML) or extensible markup language (XML).

The advertisement database 104 may store information about a number of advertisers which have contracts with a search engine service provider running the data server 101. The information about an advertiser may include, e.g., one or more keywords about its products or services, the service fee for a click (Pay Per Click) or an impression (Pay Per Impression), the expiration date of its contract with the search engine service provider, and the billing information. Although the advertisement database 104 is shown as a device external to the data server 101, it should be understood that information about advertisers may be saved in an internal memory device in the data server 101.

The computer network 103 may be, e.g., the Internet. Network connectivity may be wired or wireless, using one or more communications protocols, as will be known to those of ordinary skill in the art.

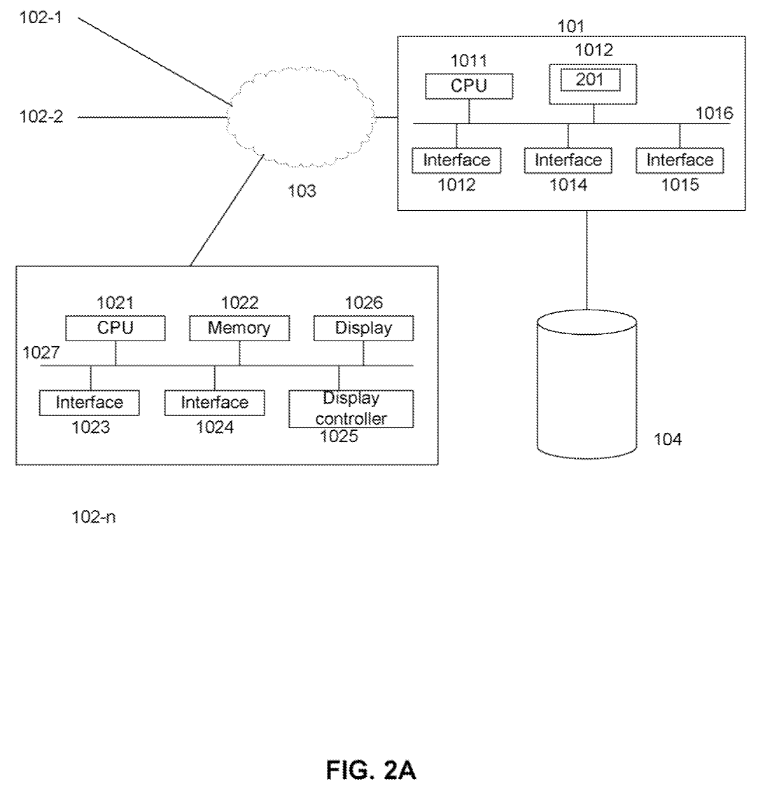

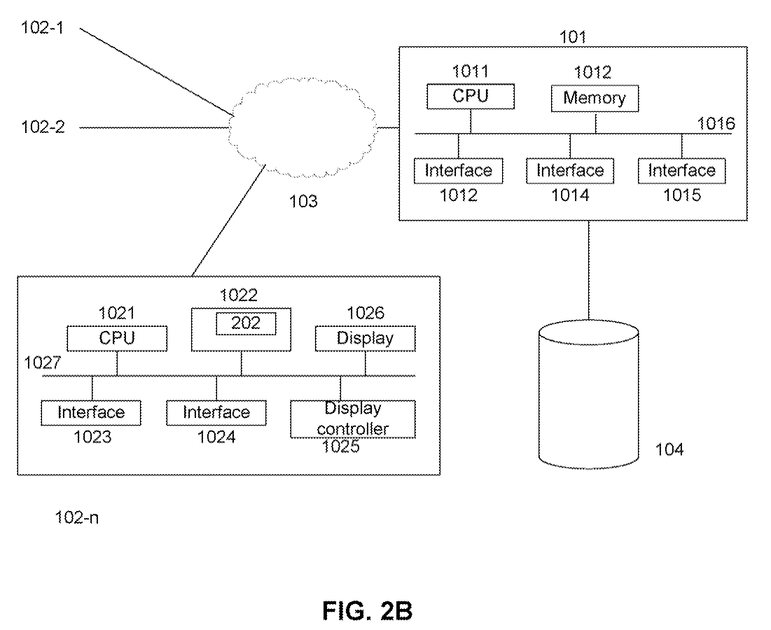

FIG. 2A illustrates a system for dynamically updating online advertisements according to one embodiment of the present invention.

A user activity analyzing module 201 may be installed in the data server 101. The user activity analyzing module 201 may be a program stored in the memory 1012. After a result page, including a list of search results on its left side and a list of advertisements on its right side, is generated and displayed to a user, the user activity analyzing module 201 may monitor the user's browsing activities on the result page, e.g., via the movements of the mouse cursor. In one embodiment, the user activity analyzing module 201 may detect which part of the result page the user has clicked on, and which part of the result page the user has moused over. The user activity analyzing module 201 may analyze content of the corresponding search result or advertisement, and obtain supplemental search terms to define the user's interest more accurately. The user activity analyzing module 201 may send the supplemental search terms to the data server 101, so that the data server 101 may search the advertisement database 104 again to obtain advertisements with the search terms from the user and the supplemental search terms from the user activity analyzing module 201, and dynamically update the advertisement list to fine tune it to the user's interest.

The user activity analyzing module 201 may differentiate the importance of the supplemental search terms. In one embodiment, a supplemental search term obtained from a part of the result page being clicked on may receive a heavier weight than a supplemental search term obtained from a part of the result page being moused over. In one embodiment, a supplemental search term obtained from a part of the result page being clicked on may receive a higher rank than a supplemental search term obtained from a part of the result page being moused over. In one embodiment, a search term's rank or weight may be correlated to the times that a supplemental search term appears. The more times a supplemental search time is abstracted from a part of the result page, the heavier the weight or the higher the rank the supplemental search term may get. It should be understood that each of these methods may be used alone or combined with other method(s).

FIG. 2B illustrates a system for dynamically updating online advertisements according to one embodiment of the present invention. Instead of being installed in the data server 101, a user activity analyzing module 202 may be installed in a user terminal 102n. The user activity analyzing module 202 may collect information about a user's browsing activities, analyze the user's interest to obtain supplemental search terms and send the supplemental search terms to the data server 101 to enable the data server 101 to refine the search. The user activity analyzing module 202 may be a program stored in a memory in the user terminal 102n.

It should be understood that the user activity analyzing module 201 or 202 may be accomplished by hardware or firmware as well.

FIG. 3 illustrates a flow chart of a method for dynamically updating online advertisements according to one embodiment of the present invention. The method may be used with the systems shown in FIGS. 2A and 2B.

At 301, the data server 101 may receive a search request from a user terminal 102n. The search request may include one or more search terms. In one example, a user is planning a trip to the New York city and has input the search terms “New York City” and “hotel.”

At 302, the data server 101, or some portion thereof such as the CPU 1011, alone or in conjunction with other elements of the server 101, may parse the search request and abstract the one or more search terms.

At 303, the data server 101 may search the Internet to identify web pages which may contain the search terms or may be relevant to the search terms.

At 304, the data server 101 may determine the relevance of the web pages using one or more algorithms.

At 305, the data server 101 may rank the web pages according to their relevance.

At 306, the data server 101 may search the advertisement database 104 to obtain advertisements relevant to the search terms “New York city” and “hotel.”

At 307, the data server 101 may rank the advertisements according to, e.g., service fee rates.

At 308, the data server 101 may send data to the user terminal 102n, so that the user terminal 102n may present on its display 1026 a list of search results and a list of advertisements on one or more result pages. The search results may include segments of web pages about hotel reviews and travel guides, and links to the web pages. The search results may also include segments of web pages of hotels and links to the hotels' websites. The advertisements may include advertisements of travel agencies and hotels. In one example, a result page may have a left column for displaying the list of search results, starting from the most relevant search result, and a right column for displaying the list of advertisements, starting from the advertisement with the highest service fee rate. The list of search results may expand over a number of result pages, and a result page may be longer than a screen.

In another example, the list of search results may be displayed in a right column of the result page, and the list of advertisements may be displayed in a left column of the result page.

At 309, the user activity analyzing module 201 or 202 may monitor the user's browsing activities. In one embodiment, the user may click on the link to a first hotel's website and then look at the introduction of the first hotel's gym.

At 310, the user activity analyzing module 201 or 202 may determine that the user is interested in a hotel with a gym and abstract “gym” as a supplemental search term and send it to the data server 101.

At 311, the data server 101 may search the advertisement database 104 again with the search terms “New York city” and “hotel” and the supplemental search term “gym” to find hotels with a gym.

At 312, the data server 101 may update the advertisement list, e.g., moving advertisements of hotels with gyms to a more conspicuous location. When the advertisement list is very long, the data server 101 may limit the list to include only advertisements of hotels with gyms.

At 313, the updated advertisement list may be displayed, e.g., when the user returns to the result page. In one embodiment, a line like “New York city hotels with gyms” may be displayed to get the user's attention.

The process may then return to 309 and the user activity analyzing module 201 or 202 may continue to monitor the user's browsing activities. If the user clicks on or mouses over another search result or advertisement, 310-313 may repeat to fine tune the advertisement list to the user's interest.

In one embodiment, the user may click on a link to a second hotel. The user activity analyzing module 201 or 202 may compare information about the second hotel and the first hotel and find out their common features. For example, if both the first hotel and the second hotel are in Midtown, the user activity analyzing module 201 or 202 may send “midtown” as a supplemental search term to the data server 101.

In one embodiment, the user activity analyzing module 201 or 202 may give different importance to supplemental search terms. For example, if the user mouses over the link to a web page of a Marriott hotel but did not click on the link, the term “Marriott” may get a “50%” weight, and will not be sent to the data server 101 unless the user mouses over the web page of a Marriott hotel again. But if a user clicks on the link to a web page of a Marriott hotel, the term “Marriott” may get a “100%” weight, and may be sent to the data server 101 as a supplemental search term.

In one embodiment, the user activity analyzing module 201 or 202 may inform the data server 101 to withdraw a supplemental search term if it conflicts with user browsing activities. For example, the user activity analyzing module 201 or 202 may have sent “luxury” as a supplemental search term to the data server 101 after the user looks at information about a luxury hotel. When the user looks at information about a cheap hotel, the user activity analyzing module 201 or 202 may inform the data server 101 to delete the supplemental search term “luxury.”

In one embodiment, instead of displaying the advertisement list at a fixed location on the result page, the updated advertisement list may be kept in the currently displayed screen when the user scrolls up and down the result page. The method for keeping the updated advertisement list in the currently displayed screen is described in the co-pending U.S. patent application Ser. No. 11/______ (Attorney Docket No. 14093/4456), entitled Method and System for Displaying Online Advertisements, which is incorporated herein by reference in its entirety.

Several features and aspects of the present invention have been illustrated and described in detail with reference to particular embodiments by way of example only, and not by way of limitation. Those of skill in the art will appreciate that alternative implementations and various modifications to the disclosed embodiments are within the scope and contemplation of the present disclosure. Therefore, it is intended that the invention be considered as limited only by the scope of the appended claims.

What is claimed is:

1. A method for updating online advertisements, the method comprising:
receiving a search term from a user terminal;
identifying a plurality of web pages relevant to the search term;
selecting a plurality of advertisements relevant to the search term;
generating a result page, with information about the web pages shown in a first portion of the result page, and the advertisements shown in a second portion of the result page;
monitoring browsing activities on the result page, and
generating an updated advertisement list with advertisements selected responsive to said browsing activities.

2. The method of claim 1, further comprising: analyzing the browsing activities to determine a user's interest and abstract a supplemental search term reflecting the user's interest.

3. The method of claim 2, further comprising: selecting advertisements using the search term and the supplemental search term.

4. The method of claim 3, further comprising: generating an updated advertisement list with advertisements selected using the search term and the supplemental search term.

5. The method of claim 4, further comprising: displaying the updated advertisement list.

6. The method of claim 5, further comprising: keeping the updated advertisement list in a currently displayed screen when a user scrolls up and down the result page.

7. The method of claim 1, wherein the browsing activities comprise clicking on a link to a web page.

8. The method of claim 1, wherein the browsing activities comprise mousing over a search result.

9. The method of claim 2, further comprising: determining the importance of a supplemental search term.

10. The method of claim 9, further comprising: when a user clicks on a first web page and mouse over a second web page, assigning a heavier weight to a supplemental search term obtained from the first web page.

11. The method of claim 9, further comprising: when a user clicked on a third web page and moused over a fourth web page, assigning a higher rank to a supplemental search term obtained from the third web page.

12. The method of claim 2, further comprising: withdrawing a supplemental search term if it conflicts with browsing activities.

13. A computer program product comprising a computer-readable medium having instructions which, when performed by a computer, perform a method for updating online advertisements, the method comprising:
receiving a search term from a user terminal;
identifying a plurality of web pages relevant to the search term;
selecting a plurality of advertisements relevant to the search term;
generating a result page, with information about the web pages shown in a first portion of the result page, and the advertisements shown in a second portion of the result page;
monitoring browsing activities on the result page; and
generating an updated advertisement list with advertisements selected responsive to said browsing activities.

14. The computer program product of claim 13, the method further comprising: analyzing the browsing activities to determine a user's interest and abstract a supplemental search term reflecting the user's interest.

15. The computer program product of claim 14, the method further comprising: selecting advertisements using the search term and the supplemental search term.

16. The computer program product of claim 15, the method further comprising: generating an updated advertisement list with advertisements selected using the search term and the supplemental search term.

17. The computer program product of claim 16, the method further comprising: displaying the updated advertisement list.

18. The computer program product of claim 13, wherein the browsing activities comprise clicking on a link to a web page.

19. The computer program product of claim 13, wherein the browsing activities comprise mousing over a search result.

20. The computer program product of claim 14, the method further comprising: determining the importance of a supplemental search term.

21. The computer program product of claim 14, the method further comprising: withdrawing a supplemental search term if it conflicts with browsing activities.

22. A computer program product comprising a computer-readable medium having instructions which, when performed by a computer, perform a method for updating online advertisements, the method comprising:
monitoring browsing activities on a result page which has a plurality of web pages relevant to a search term displayed in a first portion and has a plurality of advertisements relevant to the search term displayed in a second portion; and
generating an updated advertisement list with advertisements selected responsive to said browsing activities.

23. The computer program product of claim 22, the method further comprising: analyzing the browsing activities to determine a user's interest and abstract a supplemental search term reflecting the user's interest.

24. The computer program product of claim 23, the method further comprising: sending the supplemental search term to a search engine to enable the search engine to update the advertisement list with the supplemental search term.

25. The computer program product of claim 23, the method further comprising: determining the importance of a supplemental search term.
